(19) United States
(12) Patent Application Publication
(10) Pub. No.: US 2022/0308911 A1
(43) Pub. Date: Sep. 29, 2022

(54) SYSTEM AND METHOD FOR A DISTRIBUTED WORKFLOW SYSTEM

(71) Applicant: REX - Real Estate Exchange, Inc., Woodland Hills, CA (US)

(72) Inventors: Andy Barkett, Redwood City, CA (US); HongDa Tang, Austin, TX (US)

(21) Appl. No.: 17/703,627

(22) Filed: Mar. 24, 2022

Related U.S. Application Data
(60) Provisional application No. 63/165,409, filed on Mar. 24, 2021.

(51) Int. Cl. G06F 9/455; G06F 9/50

(52) U.S. Cl. CPC G06F 9/45558; G06F 9/5027; G06F 2009/4557

(57) ABSTRACT

A system and method for a distributed workflow system that can include: deploying a decentralized microservice cluster that is configured for a workflow application, which comprises: compiling a workflow specification configured for the workflow application into a deployment configuration, managing instantiation of a set of virtual hosts based on the deployment configuration, comprising, for each task of the workflow, instantiating a virtual host with a task service, workflow daemon, and a task router, and at a workflow daemon of each virtual host instance, receiving workflow information of the deployment configuration of the workflow application and configuring message routing of the task router; and collectively executing the workflow application within the decentralized microservice cluster comprising: at a task service of a virtual host servicing requests of a corresponding task router, and at the task router, routing responses from the task router to virtual hosts of tasks based on the message routing.

### CROSS-REFERENCE TO RELATED APPLICATIONS

This Application claims the benefit of U.S. Provisional Application No. 63,165,409, filed on 24 Mar. 2021, which is incorporated in its entirety by this reference.

### TECHNICAL FIELD

This invention relates generally to the field of distributed computing infrastructure, and more specifically to a new and useful system and method for a scalable workflow system for various applications, including real-time applications, reliable online transaction applications.

### BACKGROUND

Workflow automation has been used within computer systems to coordinate execution of various cooperating tasks. Some examples of workflow systems are disclosed in U.S. Pat. No. 6,567,783 and U.S. Patent Pub. No. 2003/0195762. Many workflow systems are highly specialized for a particular industry, such as finance or healthcare. However, most workflow systems are highly centralized and not well suited for use with modern distributed computing infrastructures, which often make use of smartphones, IoT devices, cloud computing systems and virtualization of technologies (virtualization of networks and/or computers). Thus, there is a need in the distributed computing infrastructure field to create a new and useful system and method for a scalable workflow system for distributed applications. This invention provides such a new and useful system and method.

### BRIEF DESCRIPTION OF THE FIGURES

FIG. 1 is a schematic representation of a system.

FIG. 2 is a schematic representation of a system used in implementing two distinct workflows.

FIG. 3 is a flow diagram of states of a workflow.

FIGS. 4-9 are flow diagrams of variations of the method.

FIG. 10 is an exemplary system architecture that may be used in implementing the system and/or method.

### DESCRIPTION OF THE EMBODIMENTS

The following description of the embodiments of the invention is not intended to limit the invention to these embodiments but rather to enable a person skilled in the art to make and use this invention.

### 1. Overview

A system and method for a distributed workflow system functions as a network implemented workflow system including a workflow network overlay that can dynamically route various workflow tasks for enhanced scalability, low latency, and security.

The system and method may enable an enhanced system and process for establishing and setting up a computing infrastructure for a specific workflow application and/or executing the workflow application within the computing infrastructure. In some variations, the system and method can facilitate the translating a workflow specification into a specially configured microservice-enabled computing environment executing the associated workflow.

The system and method may be specifically applicable to enabling the use of a decentralized microservice infrastructure. The system and method may extend and make use of container orchestration systems or other cluster management tools such as Kubernetes and Nomad to create a specially configured computing system for a workflow system.

The system and method of the present disclosure enables the operational integration of a set of workflow tasks (e.g., business tasks, each of which could be prototypically fulfilled by an application service), where each workflow task can be mapped to a virtual machine that implements the required application service, workflow daemon/agent, and a service router. The set of virtual machine hosts may be connected through a network (or other communication medium such as a distributed ledger/blockchain) and a centralized workflow deployment service. Variations of the system and method enable execution of a workflow without centralized coordination during runtime. The system and method can then enable the coordinated execution of a workflow defined by a directed graph of various workflow tasks. Workflow tasks are performed at a configured virtual machine host of the task. The directed graph of the workflow can be implemented through decentralized abstracted communication.

A workflow application can characterize a software application that coordinates processing performed by a set of tasks as defined by a directed graph of a workflow. The workflow application can generally be applied toward a computer-implemented execution of a business process. A workflow application can be defined or specified through a workflow specification, where the workflow specification can be a machine-readable set of parameters at least partially defining the desired operation of a workflow.

When a user designs a new workflow application or updates an existing workflow application, a new or updated workflow specification of that workflow application can be compiled into a deployment configuration. With the deployment configuration compiled, the workflow orchestrator (or a collection of workflow orchestrators each of which consists of a workflow daemon and a router) interprets the deployment configuration and dynamically configures a router to forward the communication between business-tasks/application-services. During the runtime, the result of a particular business-task/application-service is routed directly to the downstream business-task/application-service using the local router without central coordination and hence ensures scalability, minimizes the communication delay and maximizes security and robustness.

The system and method of the present disclosure can be used in the development and deployment of a computer implemented workflow system for a variety of different use cases. The system and method may have particular applications in enabling a variety of computer processes to be quickly and confidently implemented in a consistent and reliable way. In many industries, an ability to create workflows to process various tasks can be of incredible value. Industries such as real-estate, insurance, legal services, financial services, operations/logistics, and many other industries may benefit from such a system and method.

The system and method may provide a number of potential benefits. The system and method are not limited to always providing such benefits and are presented only as exemplary representations for how the system and method may be put to use. The list of benefits is not intended to be exhaustive and other benefits may additionally or alternatively exist.

As one potential benefit, the system and method may enhance scalability of workflow deployments. The system and method automate a process by which enterprise technology solutions are deployed in a highly scalable manner. The system and method may automate the setup and execution of a decentralized workflow application.

As a related potential benefit, the system and method can simplify the development and maintenance of enterprise technology solutions. In leveraging workflow design tools used in configuring and designing a workflow solution, a wider range of users can be empowered to design and customize solutions to a particular business process. For example, workers without coding experience may be able to make use of a library of configurable task types to create a custom workflow or customize an existing one. When coupled with the potential scalability benefits, the system and method can enable a wider range of users to reliably deploy scalable solutions.

As another related potential benefit, the system and method may promote a more useful workflow development process where prior work in developing specific tasks/services can be reused in other workflows. Accordingly, a library of tasks can enable task modules to be composed in arbitrary workflow solutions.

As another potential benefit, the system and method can be implemented with generalized communication transport between virtual machine hosts. As a limited list of examples, depending on technical requirements/objectives and design of a workflow application, a workflow application may be implemented using a message transport medium between virtual hosts of different tasks such as direct wired or wireless communication (e.g., TCP, UDP, etc.), a message queue system, a database, a blockchain/distributed ledger system, and/or other channels for storing and relaying messages and information between tasks. Such adaptability for different communication mediums may be used to enable the system and method to adapt to a wide variety of computing infrastructures and workflow requirements. As a decentralized implementation of a workflow application, the different transport mediums may be uniquely configured for different workflow and/or between specific tasks.

### 2. System

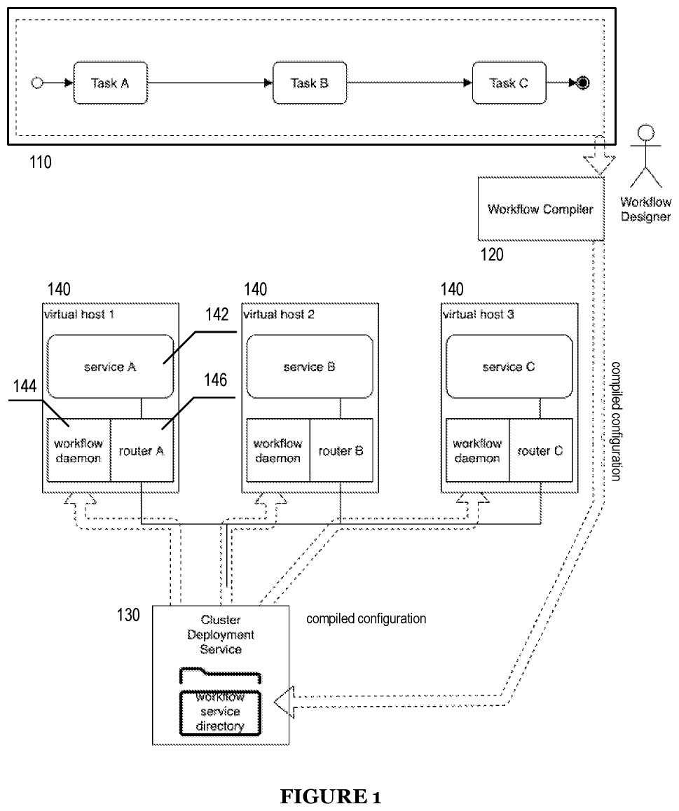

As shown in FIG. 1, a system for a distributed workflow system for real-time applications can include a workflow specification interface 110, a workflow compiler 120, a cluster deployment service 130, and a set of virtual machine hosts 140 connected through a network. The set of virtual machine hosts 140 can correspond to a task of the workflow application, and each virtual machine host can be configured with a task service, a workflow daemon, and a task router. The system functions to orchestrate the deployment and operation of a workflow application that is executed through the set of virtual machine hosts 140. The system may implement a specialized system that transforms a workflow specification into an operating workflow executing on a distributed microservice computing environment.

A workflow application is a software-based computer implemented application that can coordinate the interactions of a graph of tasks that make up a computer-implemented business process. A workflow instance (e.g., a workflow case) can be a specific instantiation of workflow application execution as a result of an event. For example, an order management workflow can be instantiated every time a new order is received and processed. Each order can result in a different workflow instance. A task generally describes a defined process or unit of work that may be performed as part of a workflow. A workflow includes a directed graph defining how inputs and outputs of tasks are communicated between them and the different states of the workflow. A task instance can be used to characterize a particular instance of a task performed for a workflow instance. In general, a task will correspond to a specific service of a virtual machine host in the computing cluster infrastructure.

A workflow application can be specified and defined through a workflow specification. A workflow specification can include data modeling and/or instructions that specify tasks to be performed, conditions of execution of the tasks, order or flow of execution be tasks; the data, documents, and/or other resources used for performing a task, and/or other aspects of a workflow. The workflow specification can include definition of a graph where the vertices of the graph are states or tasks and the edges of the graph represent flow-control/state-transition between states and/or tasks. A workflow application can be implemented to perform a wide variety of services. The workflow specification may be implemented as a data file or a set of files. The workflow specification may alternatively be a data model wherein parts or all are stored in data files, database systems, or in other computer readable mediums.

A workflow specification interface 110, functions to be an interface through which a workflow specification is defined or set. In one variation, the workflow specification interface 110 may include or connect to a workflow editor. The workflow editor can be a graphical user interface implemented as a web or native application through which a workflow designer can create or edit workflow specifications. The workflow specification interface no may include various tools to facilitate the use of a workflow editor. For example, various task templates, libraries of existing tasks, and/or other features could be integrated into a workflow editor. In some variations, the workflow specification interface 110 may be an interface through which a workflow specification created outside the system may be uploaded or otherwise added to the system.

The workflow specification interface 110 may alternatively be any suitable interface through which a workflow configuration file (or files) can be received. In some variations, the system can include an application programming interface (API) through which a workflow specification can be created or edited.

A workflow compiler 120 functions to transform a workflow specification into deployment configuration. The workflow compiler 120 can receive input of a workflow specification from the workflow specification interface no, and the workflow compiler 120 outputs a deployment configuration. A deployment configuration is a data model that defines computer infrastructure in fulfilling the workflow application. The output of the workflow compiler 120 is communicated to and saved at a workflow service directory or another computer-readable medium accessible by the cluster deployment service 130.

A cluster deployment service 130 functions as a workflow orchestrator that manages a computing cluster used in executing various workflow instances.

The cluster deployment service 130 can include a workflow service directory, which as indicated can store the deployment configurations of various workflow applications. The cluster deployment service 130 preferably ensures instantiation and operation of the computing resources used in executing one or more workflow applications. In general, a computing cluster may support multiple workflow applications, which may or may not share common task associated services (e.g., common virtual machine hosts). The cluster deployment service 130 may include or use a container orchestration system or cluster management tool such as Kubernetes or Nomad in instantiating and setting up containerized virtual machine hosts.

The cluster deployment service 130 can be configured to facilitate the instantiation and/or updating of virtual machine hosts 140 based on a deployment configuration. In some variations, once setting up the virtual machine hosts 140, the operation of the workflow may be performed within the cluster without centralized oversight by the cluster deployment service 130. The cluster deployment service 130 may however monitor and track status of the cluster such that updates can be reported as a map of workflow state or so that cluster modifications can be made.

A virtual machine host 140 (i.e., more briefly referred herein as a virtual host) functions as a workflow component corresponding to a service used in implementing a task of a workflow. The system will generally include a set of virtual hosts 140 with at least one virtual host 140 for each type of task used by the workflows. If workflow involving tasks A, B, and C is the only workflow used in configuring the system, then there may be at least three virtual hosts 140, a host 140 for A, a host 140 for B, and a host 140 for C. If the system is configured for workflow 1 with tasks A, B, and C and a second workflow 2 with tasks D, B, and E, then the set of virtual hosts 140 may include a host 140 for each of A, B, C, D, and E, where host B may provide task B processing for both workflow 1 and 2.

The virtual host 140 can be implemented as a single virtual machine or a group of virtual machines in order to allow for scalability. In the case of a group virtual machines, the traffic to the virtual host 140 may be split among the group of virtual machines for processing. The system abstraction of a virtual host 140 for a particular task/service, can make an individual virtual host 140 abstract away complexities of scaling individual task related virtual hosts 140.

A virtual host 140 can be specially configured such that it is set up for performing workflow related tasks in a decentralized manner. This may be achieved without the virtual machine host 140 having awareness of a full workflow. Though, a virtual machine host 140 may have awareness of a full workflow in some alternative variations. A virtual machine host 140 preferably includes a task service 142, a workflow daemon 144, and a task router 146, which are specially configured for the associated task.

The task service 142 functions to perform the operations related to an associated task. The task service 142 is configured to receive request input from the task router 146 (of that specific task), perform an operation (usually based on the request content), and output a response to the task router 146. The specific task operations can be defined or referenced in the workflow specification.

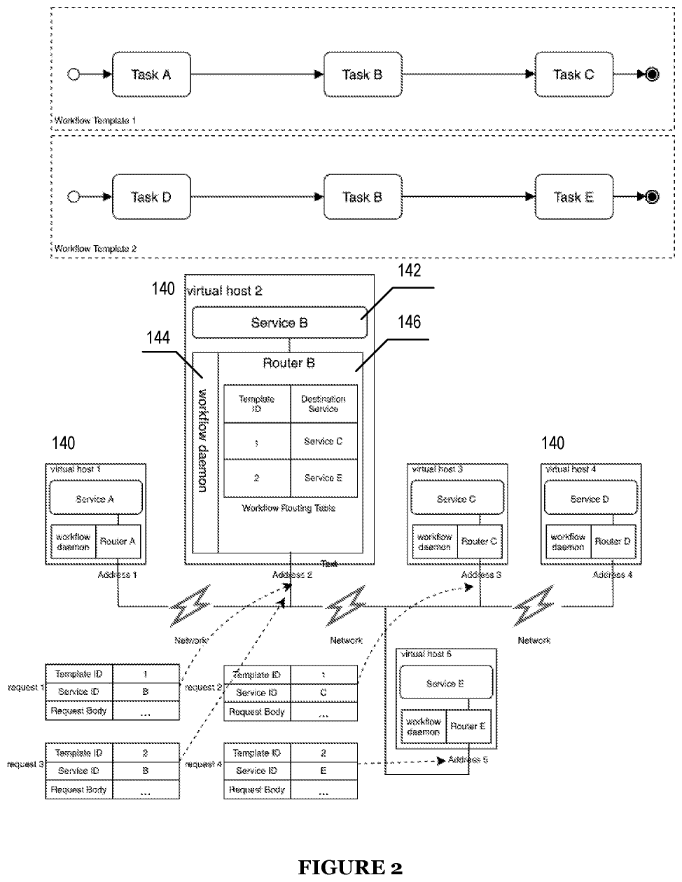

The task router 146 functions to facilitate routing of communications between different task-associated virtual machine hosts 140. The task router 146 may include a workflow routing table so that messages are received and transmitted according to workflow flow specification. As shown in FIG. 2, the workflow routing table may enable multiple workflows to be operable within a shared computing cluster.

The task router 146 may use one or more of a variety of different transport mediums for communicating messages between other task-associated virtual hosts 140. The task router 146 may additionally function to manage the specific transport medium configured for a particular task and/or workflow application. The workflow daemon 144 may manage unique configuration of how messages are communicated between virtual machine hosts 140. For a given link of a directed graph in a workflow, there may be a configured mode of message transport. Some examples of potential message transport mediums can include wired or wireless network-based communication (e.g., TCP, UDP, etc.), a message queue system, a blockchain/distributed ledger system, and/or other channels or databases for relaying messages and information between tasks.

In one example, when configured for outgoing messaging to another task via a network communication, the task router 146 can transmit or broadcast communications over a network. When configured to receive incoming messages from another task via a network communication, the task router 146 can receive incoming messages from other tasks communicated over the network.

In another example, when configured for outgoing messaging to another task via a message queue system, the task router 146 can write message results to the message queue system. When configured to receive incoming messages from another task via a message queue system, the task router 146 can receive incoming messages (e.g., via push or pull mechanisms) from the message queue system.

In another example, when configured for outgoing messages to another task via a blockchain or distributed ledger, the task router 146 can commit or record a transaction on the blockchain or distributed ledger. When configured to receive incoming messages from another task via a blockchain or distributed ledger, the task router 146 can monitor, read, or otherwise detect recording of a transaction that prompts subsequent execution of the task.

The workflow daemon 144 preferably manages control of the router according to a particular workflow application. The workflow daemon 144 can manage or control the task router 146 and how messages are directed. The workflow daemon 144 can be updated and configured with relevant workflow graph information relevant for that particular task.

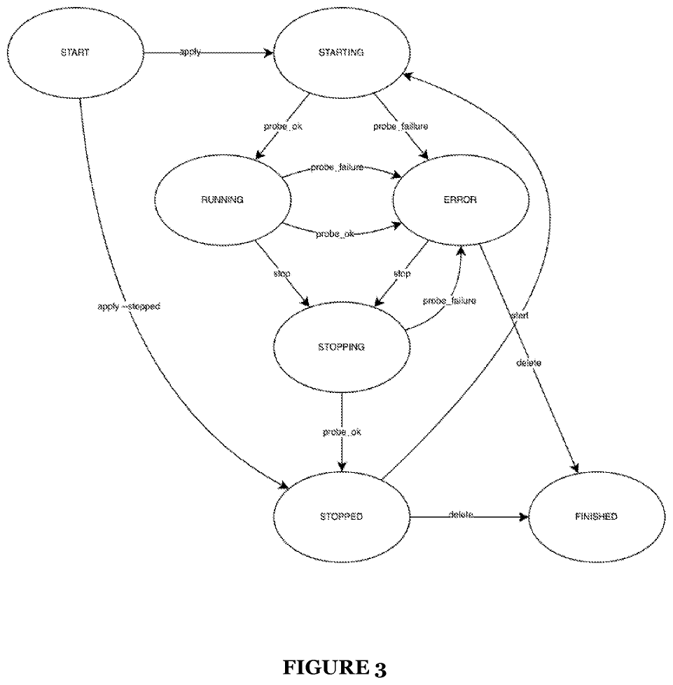

In some variations, the system may include a conceptual map that is maintained within the system. The map of workflow states can assist a user or another connected system to understand the current state of any workflow and what available lifecycle operations are available for the workflow at that particular state and what series of operations necessary to arrive at a desired state for a workflow. An interface may be exposed that enables inspection of or querying the conceptual map. As shown in FIG. 3, a state diagram can represent the states of any workflow and the transitions between the states. In particular, a workflow can begin in the START/resting state, and after the user “apply” the workflow, the workflow transitions to the STARTING state. If the STARTING workflow is probed and it is ok, then the workflow is in the RUNNING state and if it is not ok, then the workflow is in the ERROR state. Subsequently, a workflow can transition into RUNNING or ERROR state when the probe has succeeded or failed. After a user stops the workflow, whether it is RUNNING or ERROR state, the workflow is in the STOPPING state, which depends on the probe, it could further transition into STOPPED or ERROR state. Finally, a stopped or erroneous workflow becomes FINISHED after the user deletes it.

### 3. Method

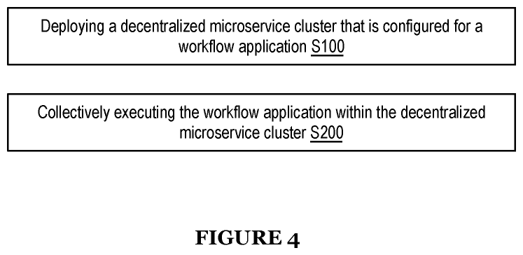

As shown in FIG. 4, a method for a scalable workflow system can include deploying a decentralized microservice cluster that is configured for a workflow application S100 and collectively executing the workflow application within the decentralized microservice cluster S200. The method can facilitate automated processes for establishing and setting up specially configured computing infrastructure for the purpose of performing the operations of a workflow application. In particular, the infrastructure is configured for decentralized execution of a workflow across a coordinating set of virtual machine hosts. Accordingly, the method can additionally or alternatively facilitate the execution of a workflow application (e.g., a customized workflow application specified through a workflow specification) within a scalable and decentralized computing infrastructure.

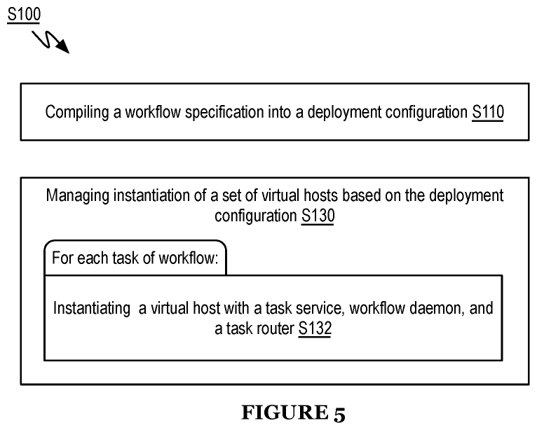

Related to the setup of computing system for workflow application, deploying a decentralized microservice cluster that is configured for a workflow application S100 can, as shown in FIG. 5, include compiling a workflow specification configured, defined, or otherwise set for the workflow application into a deployment configuration S110 and managing instantiation of a set of virtual hosts based on the deployment configuration S130, comprising, for each task of the workflow, instantiating a virtual host with a task service, workflow daemon, and a task router S132. The decentralized microservice cluster can include a cluster of virtual hosts (a set of virtual hosts) with each virtual host implemented as a single or a set of virtual machines.

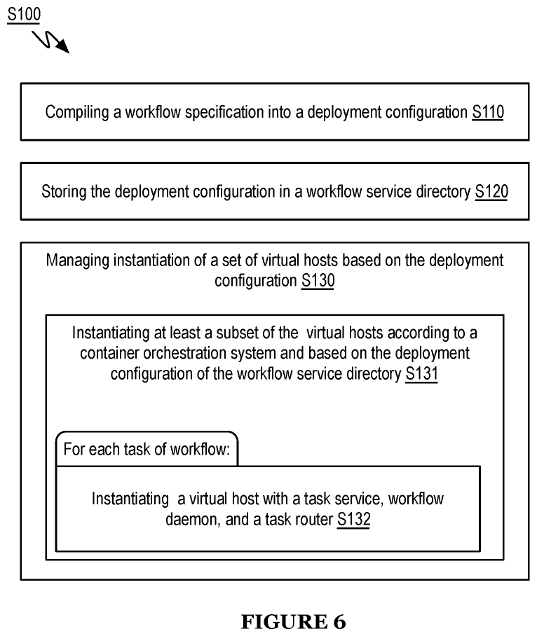

The process of translating a workflow specification into a deployed cluster, may involve the configuration of a workflow orchestrator. As shown in FIG. 6, this may include the workflow orchestrator using a container orchestration system, such as Kubernetes or Nomad, with the deployment configuration. Accordingly, a variation of the method may include: deploying a decentralized microservice cluster that is configured for a workflow application S100 can, as shown in FIG. 6, include compiling a workflow specification configured, defined, or otherwise set for the workflow application into a deployment configuration S110, storing the deployment configuration in a workflow service directory S120, managing instantiation of a set of virtual hosts based on the deployment configuration (S130), comprising instantiating at least a subset of the virtual hosts according to a container orchestration system and based on the deployment configuration of the workflow service directory S131, comprising for each task of the workflow, instantiating a virtual host with a task service, workflow daemon, and a task router S132.

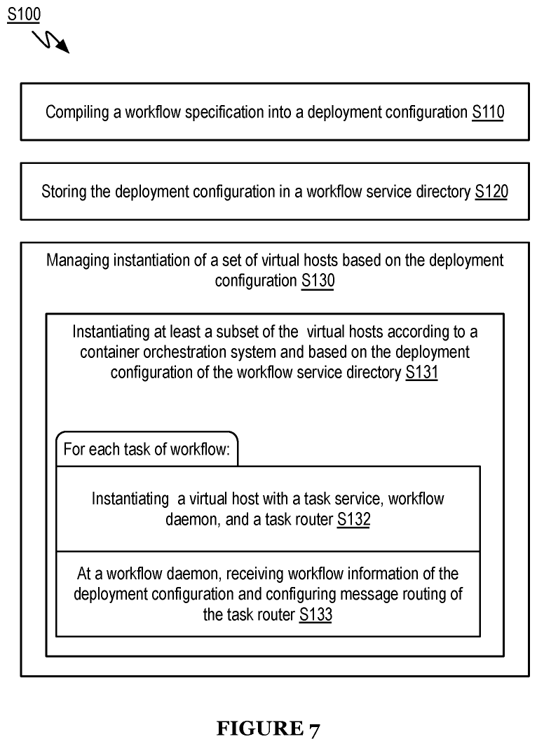

Additionally, instantiating the virtual hosts when managing instantiation of a set of virtual hosts (S130) can include, at a workflow daemon, receiving workflow information of the deployment configuration and configuring message routing of the task router S133, as shown in FIG. 7.

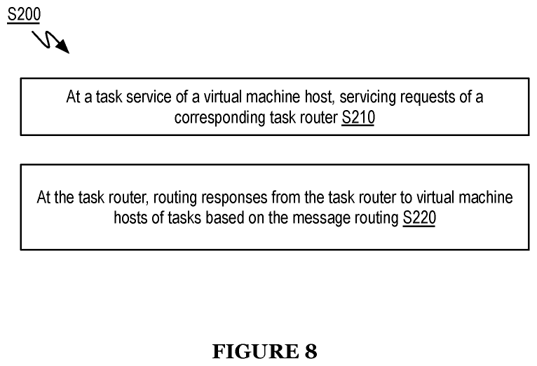

Related to the execution of a workflow application, collectively executing the workflow application within the decentralized microservice cluster S200 can, as shown in FIG. 8, include execution of the workflow application in a decentralized format which can include: at a task service of a virtual host servicing requests of a corresponding task router S210; and at the task router, routing responses from the task router to virtual hosts of tasks based on message routing (e.g., configured in S133) S220. Process S200 functions to facilitate a set of virtual hosts for various tasks of workflow application collectively executing the workflow application.

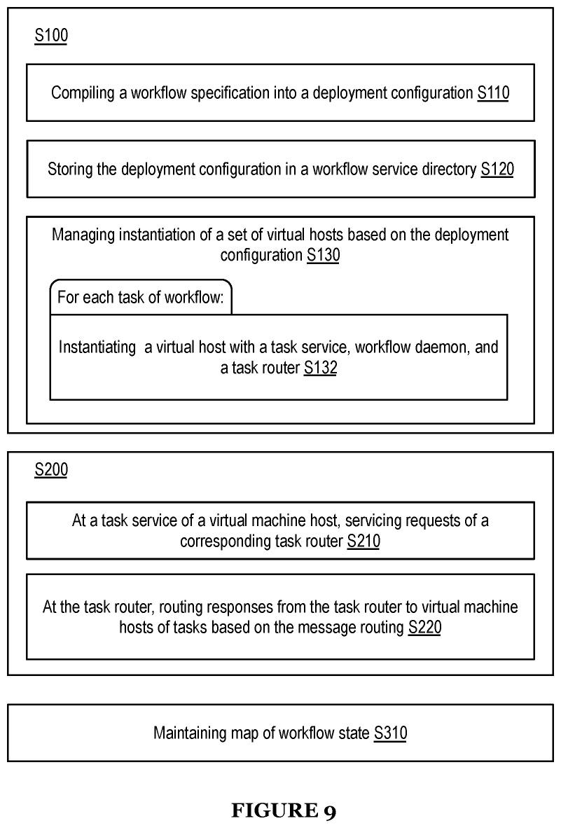

Block S100 may be used in combination in part or whole with at least a subset of S200. Accordingly, in some variations such as shown in FIG. 9, the method may more specifically include: compiling a workflow specification configured, defined, or otherwise set for the workflow application into a deployment configuration S110, in some variations storing the deployment configuration in a workflow service directory S120, managing instantiation of a set of virtual hosts based on the deployment configuration S130, comprising, for each task of the workflow, instantiating a virtual host with a task service, workflow daemon, and a task router S132; and collectively executing the workflow application S200 which includes: at a task service of a virtual host servicing requests of a corresponding task router S210; and at the task router, routing responses from the task router to virtual hosts of tasks based on the message routing S220. The method may additionally include maintaining a map of workflow state S310 as also shown in FIG. 9.

Herein, different variations and potential examples are described. These variations may be used in any suitable combination and is not limited to implementing a particular variation independent of other potential variations.

The method may be used in defining any suitable workflow. The method may have particular applicability in industries where complex workflows must be developed and deployed with high reliability and a degree of customization for different scenarios. For example, the method may be used in development and implementation of business logic workflow applications in industries such as real-estate, insurance, legal services, financial services, operations/logistics, and many other industries. Developers and potentially non-developers may be able to define and deploy scalable solutions using workflow application tools.

Block S100, which includes deploying a decentralized microservice cluster that is configured for a workflow application, functions to setup scalable computing infrastructure specially configured for scalable and efficient implementation of a workflow.

As discussed, block S100 may include compiling a workflow specification configured, defined, or otherwise set for the workflow application into a deployment configuration S110, storing the deployment configuration in a workflow service directory S120, managing instantiation of a set of virtual hosts based on the deployment configuration S130.

In some variations, block S100 or the method more generally may include receiving the workflow specification, which functions to obtain or set the workflow specification. In some variations, receiving the workflow specification may include obtaining, creating, editing, and/or otherwise setting the workflow specification. A workflow specification may be created using a variety of techniques such as through a graphical workflow editor and/or receiving document or text/data-based definition of a workflow specification. In other variations, the workflow specification may be externally created and provided as input to the method.

The workflow specification can configure or set definition of a graph where the vertices of the graph define tasks and the edges of the graph define flow control between tasks, wherein defining tasks defines association with computational service operations. The graph may be a directed graph. The tasks can characterize states of workflow and be associated with different task service operations. Definition of tasks and their association with computational service operations may be a computational instruction definition of a computational service and/or a reference to a computational service or resource (e.g., service is defined outside of workflow specification).

A workflow specification may be defined or set within a workflow specification interface 110.

In one variation, the workflow specification interface 110 may include or connect to a workflow editor. In a workflow editor variation, the method may include providing a workflow editor and receiving definition of the workflow specification through the workflow editor. Various tools may be enabled to facilitate the use of a workflow editor. For example, various task templates, libraries of existing tasks, and/or other features could be integrated into a workflow editor. Receiving workflow specification can include receiving user input defining at least in part the workflow specification and assembling the workflow specification from such user input. The workflow editor can be a graphical user interface implemented as a web or native application through which a workflow designer can create or edit workflow specifications. The workflow specification interface no may include various tools to facilitate the use of a workflow editor. For example, various task templates, libraries of existing tasks, and/or other features could be integrated into a workflow editor. The workflow editor could be a graphical no-code or low-code editor interface. For example, the workflow editor can represent the workflow specification through a graphical representation of a directed graph of connected nodes, where each node is associated with or include properties defining a task service.

In some variations, the system can include an application programming interface (API) through which a workflow specification can be created or edited. In variations involving programmatic creation of a workflow specification, a workflow specification may be specified through programmatic interface. For example, an application programming interface (API) may be provided to enable applications and services to programmatically create and modify a workflow specification. In this way, variations of the method can include receiving API requests defining or specifying parts or all of a workflow specification.

The workflow specification interface may alternatively be any suitable interface through which a workflow configuration file (or files) can be received. In variations where the workflow specification is created externally, receiving the workflow specification can include receiving a workflow specification data file. In this way, a workflow specification file or set of files can be uploaded or identified as defining the workflow specification. In one example, a user may upload a workflow specification data file which can be a text file or data object that includes definition of a workflow application.

A workflow specification interface may provide access and use to a library of task services. The task services can be flexibly composable elements that can be used in workflow specifications. In some variations, the task services may be copied, customized, referenced, forked, or used in otherwise in creating custom workflow applications.

Block S110, which includes compiling a workflow specification configured for the workflow application into a deployment configuration, functions to translate a data definition of a workflow application into a format used to configure and setup a microservice cluster.

A workflow specification (i.e., a workflow model) is a data definition of a workflow related business process that defines the details used in implementing a resulting workflow application. A workflow specification can include data modeling and/or instructions that specify tasks to be performed, conditions of execution of the tasks, order or flow of execution be tasks; the data, documents, and/or other resources used for performing a task, and/or other aspects of a workflow.

The workflow specification can fully or partially define workflow application. In one variation, the workflow specification may partially define the workflow application by defining a directed graph for transitions between different task services, while the task services (e.g., the nodes of the graph) have operations and instructions defined by an external resource. In another variation, the workflow specification may fully define the workflow application. For example, the workflow specification may define a directed graph of transitions between task services, and also include service operation specification defining the functionality of each task.

In some variations, the receiving or defining of a workflow specification may enable reuse of existing task services. In some instances, a service may already be implemented, and a workflow editor or other mechanism may enable associating a task of the workflow with a pre-implemented service. A designer of the workflow can do this during the design phase. If a library of common tasks is developed, then a designer can create new workflows without needing to develop underlying task service.

In some variations, if no pre-implemented service exists a workflow editor and/or workflow compiler may generate a placeholder task service which conforms to the specification of the task and yet actually does no significant work and associates the trivial service with the task. Such a task service may be flagged and communicated to an associated account or group of accounts such that a developer could develop and set the option of the task service.

The workflow specification may be used in directing the implementation of a workflow application, which is a software-based computer implemented application that can coordinate the interactions of a graph of task-based virtual hosts that make up a computer-implemented business process. A workflow specification can include definition of a graph where the vertices or nodes of the graph are states or tasks and the edges of the graph represent flow control between states and/or tasks. A workflow application can be implemented to perform a wide variety of services.

A workflow may be decomposable into discrete tasks, which as described herein can correspond to a particular service, as such the workflow specification can characterize or identify these tasks (or services) and the interactions between the tasks. As one example shown in FIG. 1, one exemplary workflow can have three tasks (Task A, Task B and Task C). A single workflow is eventually decomposed into irreducible/convenient tasks. Each of these tasks are triggered when the task it depended upon has finished or when an event has happened. In the example of FIG. 1, Task A is dependent on the start event denoted by the circle and Task B is dependent on the completion of Task A and Task C is dependent on the completion of Task B. Finally, when Task C has completed it will raise a finished event. Any suitably workflow and topology of tasks may be defined in a workflow specification.

In one variation, a workflow specification can be specified as a business process model and notation (BPMN), extensible markup language (XML) document(s), alternative suitable formats may alternatively be used.

Compiling a workflow specification into a deployment configuration translates the workflow specification into deployment configurations used in defining a cluster deployment that can execute the workflow application defined in the workflow specification. The workflow specification is preferably compiled by a workflow compiler. The deployment configuration can be a compiled representation of the graph data and/or operational definition of task services into a format that can be deployed in a decentralized microservice cluster.

Block S120, storing the deployment configuration in a workflow service directory, functions to communicate the compiled deployment configuration to a cluster deployment service. In one variation, a container orchestration system (e.g., Kubernetes, Nomad, or another suitable tool) is used in deploying the decentralized microservice cluster. The deployment configuration can be stored in conjunction with the container orchestration system and used by the container orchestration system in managing the microservice cluster. In such variations, managing instantiation of a set of virtual hosts S130 can include instantiating at least a subset of the virtual hosts according to a container orchestration system and based on the deployment configuration of the workflow service directory. In such variations, the container orchestration system may be selected from the set including Kubernetes and Nomad. Other alternative container orchestration systems or assembled systems used in managing containerized microservice clusters may be used.

Storing the deployment configuration, can include storing network topology and characterizations of how traffic moves between hosts. The deployment configuration is preferably stored within a workflow service directory within the cluster deployment service. Alternative approaches may be used to relay the deployment configuration to a cluster deployment service for deployment of infrastructure.

Storing the deployment configuration can include communicating the deployment configuration to a workflow orchestrator. This will generally occur in response to receiving a deployment request from a workflow specification interface. This may happen when a new workflow is finalized and deployed. This may also happen when changes are made to an existing workflow.

Block S130, which includes managing instantiation of the set of virtual hosts, functions to deploy, make any updates, and/or validate setup of a microservice cluster infrastructure for handling execution of the workflow application.

In some variations, the deployment configuration is stored in the workflow service directory (e.g., through S120) and is interpreted and carried out by the cluster deployment service, which may involve using a container orchestration system or cluster management tool such as Kubernetes or Nomad. Accordingly, S130 may include instantiating at least a subset of the virtual hosts according to a container orchestration system and based on the deployment configuration of the workflow service directory S131.

In the exemplary workflow involving task A, task B, and task C, a virtual machine host can be instantiated for each of task A, B, and C.

Instantiating of the set of virtual hosts may be based on state of a current microservice cluster. In some variations, multiple workflows may share resources of a virtual machine hosts. In these variations, a virtual machine host may already be deployed and available for use with a workflow. Managing instantiation of the set of virtual hosts can involve ensuring instantiation of the virtual machine hosts for at least each task of a workflow. In some cases, services may already be instantiated and so managing and ensuring instantiation may verify status of the virtual host of a service and optionally make any changes to the virtual machine host. Alternatively, if a service for performance of a task is not available or has not yet been instantiated, then ensuring instantiation of the virtual host can include instantiating the virtual machine host or a set of virtual machine hosts.

In this way, managing instantiation of the set of virtual hosts may include, for each task, instantiating a virtual host if a compatible virtual host is not available for use in the microservice cluster, or identifying and selecting an instantiated compatible virtual host that is compatible for use for a task of the workflow depending on state of the microservice cluster.

More specifically this can include: for each task of the deployment configuration, inspecting existing microservice cluster, and if a compatible virtual host is instantiated and/or available, selecting the compatible virtual host for association with a task of the workflow, and if a compatible virtual host is not instantiated and/or not available, instantiating a new instance of a compatible virtual host. A virtual host may be considered available if capacity of the virtual host is within capacity limits (e.g., peak utility is below a threshold, number of associated workflows is below a threshold, etc.).

In other variations, workflows may be deployed as new microservice clusters where inspection of a microservice cluster and conditional instantiation may not be warranted. In these variations, managing instantiation of the set of virtual hosts may include directly instantiating the set of virtual hosts.

In one variation, an instantiated virtual host contains a task service, workflow daemon, and a task router. Managing instantiation of a set of virtual hosts may setup a cluster where each virtual host implements a task service, a workflow daemon and a task router. This may include deploying and instantiating (or configuring a current virtual host) according to deployment configuration. Accordingly, managing instantiation of a set of virtual hosts S130, may include, for each task of the workflow, instantiating (or configuring) a virtual host with a task service, workflow daemon, and a task router S132.

Instantiating such a virtual host of block S132 can include configuring the task service with service definition wherein upon receiving a request input through the task router, the task service processes the request defined through a service definition, and responds with a service response; configuring the workflow daemon and configuring the task router for routing between virtual hosts associated with connected tasks.

The task service performs the operations related to the given task, which generally involves receiving request input through the task router (of that specific task) and responding with a result. The specific task operations can be defined or referenced in the workflow specification. In the case where a service for a task exists, a workflow specification may make reference to a service identifier or service definition resource. Configuration of the task service can set the executable service used for fulfilling a particular task.

The task router facilitates routing of communications between different task-associated virtual machine hosts. This may involve setting up addressing and route assignments of different virtual hosts.

A task router is configured to indicate for different workflows how messages are received and/or transmitted. This functions to configure the implementation of the directed graph aspect of a workflow. Configuration for routing between virtual hosts associated with connected tasks can setup a table for where inbound messages may be received and/or where outbound messages may be sent. This can enable state transitions between tasks to be decentralized wherein each virtual host includes knowledge on how inbound and/or outbound messages are handled. Such routing information may also include workflow identifying information such that routing can be conditional based on the workflow associated with a message.

The workflow daemon preferably manages control of the router according to a particular workflow application. The workflow daemon can manage or control the task router and how messages are directed. The workflow daemon is preferably updated and configured with relevant workflow graph information relevant for that particular task. Accordingly, in connection with instantiation and setup of a given workflow daemon, the method can include receiving, at a workflow daemon, workflow information of the deployment configuration (of the workflow application) and configuring message routing of the task router S133.

As discussed herein various, various transport mediums may be used such as direct wired or wireless communication (e.g., TCP, UDP, etc.), a message queue system, a blockchain/distributed ledger system, and/or other channels for relaying messages and information between tasks. The same transport medium may be used for all task-to-task communication of a particular workflow. Alternatively, different transport mediums may be implemented for different legs of a graph in a workflow application. Accordingly, this may involve, at a task router, configuring the virtual machine hosts that are the destination/originators of messages, how messages are broadcasted, where messages/data should be written, API interface configuration for writing data to a secondary service/system (e.g., a blockchain system, a communication platform), and/or any suitable type of configuration used in establishing a medium by which messages can be communicated.

In the case of Task A in the exemplary workflow application shown in FIG. 1, Cluster Deployment Service deploys the service A which is responsible for Task A onto virtual host 1 and makes workflow daemon aware that service A participates in the workflow as Task A, and the service B is dependent on service A. The workflow daemon configures router A accordingly, such that when service A's response will get automatically forwarded to virtual host 2. The same process also happens for Task B and Task C with respect to virtual host 2 and virtual host 3.

In some variations, a virtual machine host may perform a particular task and may be involved in multiple different workflows that have a shared task. The corresponding daemon can be updated to maintain a data model for how to appropriately route service responses for a given workflow identifier.

Block S200, which includes collectively executing the workflow application at the set of virtual hosts S200, functions to perform the operations of the workflow application. In executing the workflow application, after initiating request starts the workflow, the virtual hosts relay messages between the appropriate virtual host in a decentralized manner. The method can have the potential benefit of avoiding a centralized orchestration service to coordinate the workflow execution. As described herein, the virtual hosts can be configured with workflow information such that messages (and thereby workflow state) can transfer between task-associated virtual hosts directly (e.g., without coordination with a centralized orchestration service).

Each service participating in a workflow may be handed a request by the router in the same virtual host and responds to the request with a response back to the router. Each service can be unaware of upstream or downstream services. In some implementations, a service may have no configured information (“awareness”) of the workflow in general. The service can provide a piece of functionality which fulfills a task specified in a workflow, and the workflow daemon in every virtual host can understand (e.g., is configured with −) the overall workflow and its relative position in the workflow and configures the router in the same virtual host to route requests and responses in an expeditious and scalable manner.

Accordingly, collectively executing the workflow application at the set of virtual hosts S200 can include: at a task service of a virtual host, servicing requests of a corresponding task router S210; and, at the task router, routing responses from the task router to virtual hosts of tasks based on the message routing (e.g., configured in S133) S220.

Block S210, which includes servicing requests of a task router at a task service of a virtual host, functions to have a service of a virtual host perform the operations configured for the task. Block S210 and the servicing of requests performs the associated task defined within the workflow application. The service is generally task specific. As detailed, a task router delivers a request to the service, the service performs one or more operations in processing the request, and then communicates a response to the task router, which then proceeds to block S220.

The task service can be configured without external state and can be performed without awareness of the workflow or how execution of the task should be handled after completion. The response or result of processing the request is passed to the task router which in coordination with the workflow daemon propagates and communicates a message to the microservice cluster for handling by another virtual host.

Block S220, which includes routing responses from the task router to virtual hosts of tasks based on the message routing (e.g., configured in X133), functions to apply the graph defined in the workflow specification to how messages (e.g., the responses from the service) are handled. The workflow daemon of the virtual host manages control of the router so that messages are appropriately routed.

In one variation, the virtual hosts are communicatively connected to a network through which messages are communicated. The messages in one implementation can be a data packet specifying a workflow instance (e.g., a template ID), a targeted service, and a request body. The workflow instance can identify a particular workflow application and/or instance of execution of that workflow. The targeted service may be specified as a service identifier so that the appropriate task router for the identified service will process the message.

The task router after receiving a response from the service, the routing table can then communicate an outbound message to the network. The task router can include a workflow routing table that maintains a mapping of workflow identifiers to destination services. This table in some variations may additionally include conditional logic if the routing of a message depends on the results of the service.

Routing responses from the task router can include propagating an outbound message across a communication network medium integrated with the set of virtual hosts. The outbound message can include the response and other data packet information as described herein.

As discussed herein, the transport medium used in communicating messages to and/or from a task may be implemented using a variety of transport mediums such as direct wired or wireless communication (e.g., TCP, UDP, etc.), a message queue system, a blockchain/distributed ledger system, and/or other channels for relaying messages and information between tasks. Accordingly, the communication network medium may be any suitable medium through which information may be transferred directly or indirectly. In one example, the communication network medium may be a wired network connection using TCP or UDP. In another example, the communication network medium may be implemented as data integration with a distributed ledger.

As shown in FIG. 2, one exemplary scenario may involve two workflow templates, 1 and 2 where a Task B participates in both workflows. In workflow 1, Task B depends on Task A and Task B is depended upon by Task C. In workflow 2, Task B depends on Task D and Task B is depended upon by Task E. In this example, service B performs the operations for Task B. Service B may be operatively independent from and without awareness of the workflows in which Service B participates. Task Router B is levered to deliver appropriate requests to service B and route responses from service B to an appropriate next service. Since Task B participates in two workflows, the routing table for Router B has two entries. A first routing table record says for service B's response with Template ID of 1, forward the response to Service C, which performs the operations of Task C in the Workflow Template 1. The second routing table record in the routing table says for service B's response with Template ID of 2, forward the response to Service E, which performs the operations of Task E in the Workflow Template 2. For example, when request 1 (which has the Template ID of 1), comes to Address 2, the router directly forwards the request to Service B. After Router B receives the response from Service B, it composed a new request 2 to Service C in accordance with the Workflow Routing Table with Request Body consisting of the response from Service B. Similarly, when request 3(which has the Template ID of 2), comes to Address 2, the router directly forwards the request to Service B. After Router B receives the response from Service B, it composed a new request 4 to Service E in accordance with the Workflow Routing Table with Request Body consisting of the response from Service B. In both cases, Router B is able to route directly to downstream services with a single lookup from the Workflow Routing Table.

In some variations, the method may additionally include maintaining a map of workflow state S310, which functions to facilitate the management and control of the workflow which could be deployed on multiple virtual hosts and connected by a network. The map of workflow states can assist a user or another connected system to understand the current state of any workflow and what available lifecycle operations are available for the workflow at that particular state and what series of operations necessary to arrive at a desired state for a workflow. As shown in FIG. 3, a state diagram can represent the states of any workflow and the transitions between the states. In particular, a workflow can begin in the START/resting state, and after the user “apply” the workflow, the workflow transitions to the STARTING state. If the STARTING workflow is probed and it is ok, then the workflow is in the RUNNING state and if it is not ok, then the workflow is in the ERROR state. Subsequently, a workflow can transition into RUNNING or ERROR state when the probe has succeeded or failed. After a user stops the workflow, whether it is RUNNING or ERROR state, the workflow is in the STOPPING state, which depends on the probe, it could further transition into STOPPED or ERROR state. Finally, a stopped or erroneous workflow becomes FINISHED after the user deletes it.

### 4. System Architecture

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

In one variation, a system comprising of one or more computer-readable mediums (e.g., non-transitory computer-readable medium) storing instructions that, when executed by the one or more computer processors, cause a computing platform to perform operations comprising those of the system or method described herein such as: deploying decentralized microservice cluster that is configured for a workflow application and collectively executing the workflow application within the decentralized microservice cluster and any process variations described herein.

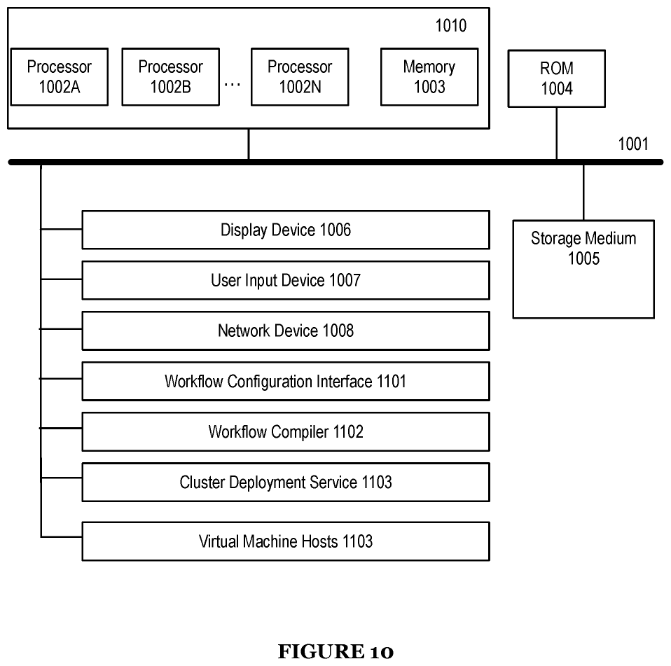

FIG. 10 is an exemplary computer architecture diagram of one implementation of the system. In some implementations, the system is implemented in a plurality of devices in communication over a communication channel and/or network. In some implementations, the elements of the system are implemented in separate computing devices. In some implementations, two or more of the system elements are implemented in same devices. The system and portions of the system may be integrated into a computing device or system that can serve as or within the system.

The communication channel 1001 interfaces with the processors 1002A-1002N, the memory (e.g., a random access memory (RAM)) 1003, a read only memory (ROM) 1004, a processor-readable storage medium 1005, a display device 1006, a user input device 1007, and a network device 1008. As shown, the computer infrastructure may be used in connecting a workflow configuration interface 1101, a workflow compiler 1102, a cluster deployment service 1103, and a set of virtual machine hosts 1104, and/or other suitable computing devices.

The processors 1002A-1002N may take many forms, such CPUs (Central Processing Units), GPUs (Graphical Processing Units), microprocessors, ML/DL (Machine Learning/Deep Learning) processing units such as a Tensor Processing Unit, FPGA (Field Programmable Gate Arrays, custom processors, and/or any suitable type of processor.

The processors 1002A-1002N and the main memory 1003 (or some sub-combination) can form a processing unit 1010. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip). In some embodiments, the processing unit includes one or more of the elements of the system.

A network device 1008 may provide one or more wired or wireless interfaces for exchanging data and commands between the system and/or other devices, such as devices of external systems. Such wired and wireless interfaces include, for example, a universal serial bus (USB) interface, Bluetooth interface, Wi-Fi interface, Ethernet interface, near field communication (NFC) interface, and the like.

Computer and/or Machine-readable executable instructions comprising of configuration for software programs (such as an operating system, application programs, and device drivers) can be stored in the memory 1003 from the processor-readable storage medium 1005, the ROM 1004 or any other data storage system.

When executed by one or more computer processors, the respective machine-executable instructions may be accessed by at least one of processors 1002A-1002N (of a processing unit 1010) via the communication channel 1001, and then executed by at least one of processors 1001A-1001N. Data, databases, data records or other stored forms data created or used by the software programs can also be stored in the memory 1003, and such data is accessed by at least one of processors 1002A-1002N during execution of the machine-executable instructions of the software programs.

The processor-readable storage medium 1005 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. The processor-readable storage medium 1005 can include an operating system, software programs, device drivers, and/or other suitable sub-systems or software.

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

As a person skilled in the art will recognize from the previous detailed description and from the figures and claims, modifications and changes can be made to the embodiments of the invention without departing from the scope of this invention as defined in the following claims.

We claim:

1. A method comprising:
deploying a decentralized microservice cluster that is configured for a workflow application, which comprises:
compiling a workflow specification configured for the workflow application into a deployment configuration,
managing instantiation of a set of virtual hosts based on the deployment configuration, comprising, for each task of the workflow, instantiating a virtual host with a task service, workflow daemon, and a task router, and
at a workflow daemon of each virtual host instance, receiving workflow information of the deployment configuration of the workflow application and configuring message routing of the task router; and
collectively executing the workflow application within the decentralized microservice cluster comprising:
at a task service of a virtual host servicing requests of a corresponding task router, and
at the task router, routing responses from the task router to virtual hosts of tasks based on the message routing.

2. The method of claim 1, wherein instantiating the virtual host with a task service, workflow daemon, and a task router comprises:
configuring the task service with service definition wherein upon receiving a request input through the task router, the task service processes the request defined through a service definition, and responds with a service response,
configuring the workflow daemon and configuring the task router for routing between virtual hosts associated with connected tasks.

3. The method of claim 1, wherein routing responses from the task router to virtual hosts of tasks based on the message routing comprises communicating an outbound message as a data packet specifying a workflow instance, a targeted service, and a request body.

4. The method of claim 1, further comprising receiving the workflow specification wherein the workflow specification configures definition of a graph where the vertices of the graph define tasks and the edges of the graph define flow control between tasks, wherein defining tasks defines association with computational service operations.

5. The method of claim 1, further comprising storing the deployment configuration in a workflow service directory, and wherein managing instantiation of a set of virtual hosts comprises instantiating at least a subset of the virtual hosts according to a container orchestration system and based on the deployment configuration of the workflow service directory.

6. The method of claim 5, wherein the container orchestration system is selected from the set including Kubernetes and Nomad.

7. The method of claim 1, further comprising maintaining a map of workflow state.

8. A non-transitory computer-readable medium storing instructions that, when executed by one or more computer processors of a computing platform, cause the computing platform to:
deploying a decentralized microservice cluster that is configured for a workflow application, which comprises:
compiling a workflow specification configured for the workflow application into a deployment configuration,
managing instantiation of a set of virtual hosts based on the deployment configuration, comprising, for each task of the workflow, instantiating a virtual host with a task service, workflow daemon, and a task router, and
at a workflow daemon of each virtual host instance, receiving workflow information of the deployment configuration of the workflow application and configuring message routing of the task router; and
collectively executing the workflow application within the decentralized microservice cluster comprising:
at a task service of a virtual host servicing requests of a corresponding task router, and
at the task router, routing responses from the task router to virtual hosts of tasks based on the message routing.

9. The non-transitory computer-readable medium of claim 8, wherein instantiating the virtual host with a task service, workflow daemon, and a task router comprises:
configuring the task service with service definition wherein upon receiving a request input through the task router, the task service processes the request defined through a service definition, and responds with a service response,
configuring the workflow daemon and configuring the task router for routing between virtual hosts associated with connected tasks.

10. The non-transitory computer-readable medium of claim 8, wherein routing responses from the task router to virtual hosts of tasks based on the message routing comprises communicating an outbound message as a data packet specifying a workflow instance, a targeted service, and a request body.

11. The non-transitory computer-readable medium of claim 8, further comprising receiving the workflow specification wherein the workflow specification configures definition of a graph where the vertices of the graph define tasks and the edges of the graph define flow control between tasks, wherein defining tasks defines association with computational service operations.

12. The non-transitory computer-readable medium of claim 8, further comprising storing the deployment configuration in a workflow service directory, and wherein managing instantiation of a set of virtual hosts comprises instantiating at least a subset of the virtual hosts according to a container orchestration system and based on the deployment configuration of the workflow service directory.

13. The non-transitory computer-readable medium of claim 12, wherein the container orchestration system is selected from the set including Kubernetes and Nomad.

14. The non-transitory computer-readable medium of claim 8, further comprising maintaining a map of workflow state.

15. A system comprising of:
one or more computer-readable mediums storing instructions that, when executed by the one or more computer processors, cause a computing platform to perform operations comprising:
deploying a decentralized microservice cluster that is configured for a workflow application, which comprises:
compiling a workflow specification configured for the workflow application into a deployment configuration,
managing instantiation of a set of virtual hosts based on the deployment configuration, comprising, for each task of the workflow, instantiating a virtual host with a task service, workflow daemon, and a task router, and
at a workflow daemon of each virtual host instance, receiving workflow information of the deployment configuration of the workflow application and configuring message routing of the task router; and
collectively executing the workflow application within the decentralized microservice cluster comprising:
at a task service of a virtual host servicing requests of a corresponding task router, and
at the task router, routing responses from the task router to virtual hosts of tasks based on the message routing.

16. The system of claim 15, wherein instantiating the virtual host with a task service, workflow daemon, and a task router comprises:
configuring the task service with service definition wherein upon receiving a request input through the task router, the task service processes the request defined through a service definition, and responds with a service response,
configuring the workflow daemon and configuring the task router for routing between virtual hosts associated with connected tasks.

17. The system of claim 15, wherein routing responses from the task router to virtual hosts of tasks based on the message routing comprises communicating an outbound message as a data packet specifying a workflow instance, a targeted service, and a request body.

18. The system of claim 15, further comprising receiving the workflow specification wherein the workflow specification configures definition of a graph where the vertices of the graph define tasks and the edges of the graph define flow control between tasks, wherein defining tasks defines association with computational service operations.

19. The system of claim 15, further comprising storing the deployment configuration in a workflow service directory, and wherein managing instantiation of a set of virtual hosts comprises instantiating at least a subset of the virtual hosts according to a container orchestration system and based on the deployment configuration of the workflow service directory.

20. The system of claim 15, further comprising maintaining a map of workflow state.
